(19) United States
(12) Patent Application Publication
(10) Pub. No.: US 2003/0187806 A1
(43) Pub. Date: Oct. 2, 2003

(54) Calculating and displaying the cost of downloading web content

(75) Inventors: Dwip N. Banerjee, Austin, TX (US); Michael Wayne Brown, Georgetown, TX (US); Mark Joseph Hamzy, Round Rock, TX (US); Kumar Ravi, Cedar Park, TX (US)

Correspondence Address: BIGGERS & OHANIAN, PLLC, 5 SCARLET RIDGE, AUSTIN, TX, 78737, US

(73) Assignee: INTERNATIONAL BUSINESS MACHINES CORPORATION, ARMONK, NY

(21) Appl. No.: 10/112,485

(22) Filed: Mar. 28, 2002

(51) Int. Cl. G06F 17/00; G06G 7/00

(52) U.S. Cl. 705/400

(57) ABSTRACT

A method for calculating and displaying the cost of downloading web content, including downloading to a browser a first web page, the first web page including at least one hyperlink anchor element, in which the hyperlink anchor element includes a URI identifying a second web page, the hyperlink anchor element includes text including a hyperlink anchor. Typical embodiments include determining a download cost for the second web page and displaying the cumulative download cost for the second web page, taking into account bandwidth cost, usage cost, and any user credits.

### BACKGROUND OF THE INVENTION

1. Field of the Invention

The field of the invention is data processing, or, more specifically, methods, systems, and products for calculating and displaying the cost of downloading web content.

2. Description of Related Art

When browsing the web using PDAs and other web-enabled devices, there are links which charge the user a certain amount of money for using the link, and/or other costs for downloading dependent upon factors such as cost of using a certain bandwidth, the number of PDA pages, the amount of memory required on the PDA, and so on. In addition, bandwidth charges and other costs sometimes originate with an internet service provider (“ISP”) or other communications providers rather than from a link, web site, or content provider. Moreover, there are sometimes incentives offered by content owners, for advertising, for example, for using the owner's web page where the web site owner or content owner may agree to pay the user for using their site. In present art, however, there is no way for a user to know at the time of invoking a link what it will cost to access a particular web page through a particular link, although it would be very useful if there were.

### SUMMARY OF THE INVENTION

Exemplary embodiments of the invention typically include methods for calculating and displaying the cost of downloading web content. Embodiments typically include downloading to a browser a first web page, the first web page typically including at least one hyperlink anchor element, the hyperlink anchor element including a URI identifying a second web page. The hyperlink anchor element typically includes text comprising a hyperlink anchor, and the browser typically operates in a web-enabled device that includes a user interface. Exemplary embodiments typically include determining a download cost for the second web page, and displaying, through the user interface, the download cost for the second web page.

In exemplary embodiments of the invention, determining a download cost for the second web page typically includes multiplying an estimated file size for the second web page, a download bandwidth for a web-enabled device, and a bandwidth usage cost for the a web-enabled device. In some embodiments, the first web page typically includes a download cost markup element for the second web page. In some embodiments, the download cost markup element includes the URI identifying the second web page, and a second web page size. In typical embodiments, determining a download cost for the second web page includes determining a download bandwidth for use by the web-enabled device, determining a bandwidth cost in dependence upon the download bandwidth, and multiplying the second web page size, the download bandwidth, and the bandwidth usage cost.

In exemplary embodiments of the invention, determining a download cost for the second web page typically includes constructing, in the browser, a query URI representing a query of a download cost database through a download cost web server for the download cost for the second web page, in which the query URI typically includes the URI identifying the second web page and a download bandwidth for the web-enabled device, and the download cost database typically includes data fields for URIs identifying web pages, download bandwidths, and download costs. Some embodiments typically include transmitting the query URI to the download cost web server in an HTTP ‘get’ message, and receiving, as a query result from the download cost web server, the download cost for the second web page.

In exemplary embodiments of the invention, the first web page typically includes a download cost markup element for the second web page, the download cost markup element including the URI identifying the second web page, and a web site usage charge parameter identifying a web site usage charge for downloading the second web page. Exemplary embodiments typically include determining a download cost for the second web page including reading, from the web site usage charge parameter, a web site usage charge for downloading the second web page, and adding the web site usage charge to the download cost for the second web page.

In typical embodiments of the invention, the first web page includes a download cost markup element for the second web page, the download cost markup element including the URI identifying the second web page, and a web site usage credit parameter identifying a web site usage charge for downloading the second web page. Some embodiments typically include determining a download cost for the second web page including reading, from the web site credit parameter, a web site usage credit for downloading the second web page, and subtracting the web site usage credit from the download cost for the second web page. In some embodiments, the download cost for the second web page typically includes a numeric download cost, and the hyperlink anchor element includes text comprising a hyperlink anchor. In other embodiments, displaying the download cost for the second web page typically includes converting the numeric download cost for the second web page to a text download cost for the second web page, inserting the text download cost into the hyperlink anchor, and displaying the first web page.

The foregoing and other objects, features and advantages of the invention will be apparent from the following more particular descriptions of exemplary embodiments of the invention as illustrated in the accompanying drawings wherein like reference numbers generally represent like parts of exemplary embodiments of the invention.

### BRIEF DESCRIPTION OF THE DRAWINGS

FIG. 1 is a data flow diagram illustrating typical example embodiments of the invention.

FIG. 2 is a data flow diagram further illustrating typical example embodiments of the invention particularly with respect to determining download costs for web pages.

FIG. 3 is a data flow diagram further illustrating typical example embodiments of the invention particularly with respect to determining download costs for web pages, particularly for embodiments that obtain bandwidth usage costs from remote online sources.

FIG. 4 is a data flow diagram further illustrating typical example embodiments of the invention particularly with respect to determining download costs for web pages, particularly for embodiments that obtain, in dependence upon URIs and download bandwidths, download costs from remote online sources.

FIG. 5 is a data flow diagram further illustrating typical example embodiments of the invention particularly with respect to determining download costs for web pages, particularly with respect to charges and credits for web site usage.

FIG. 6 is a data flow diagram illustrating typical example embodiments of the invention particularly regarding displaying download costs for web pages, particularly with respect to embodiments that convert numeric costs to text and insert the text into HTML anchors.

### DETAILED DESCRIPTION OF EXEMPLARY EMBODIMENTS

Introduction

The present invention is described to a large extent in this specification in terms of methods for calculating and displaying the cost of downloading web content. Persons skilled in the art, however, will recognize that any computer system that includes suitable programming means for operating in accordance with the disclosed methods also falls well within the scope of the present invention.

Suitable programming means include any means for directing a computer system to execute the steps of the method of the invention, including for example, systems comprised of processing units and arithmetic-logic circuits coupled to computer memory, which systems have the capability of storing in computer memory, which computer memory includes electronic circuits configured to store data and program instructions, programmed steps of the method of the invention for execution by a processing unit. The invention also may be embodied in a computer program product, such as a diskette or other recording medium, for use with any suitable data processing system.

Embodiments of a computer program product may be implemented by use of any recording medium for machine-readable information, including magnetic media, optical media, or other suitable media. Persons skilled in the art will immediately recognize that any computer system having suitable programming means will be capable of executing the steps of the method of the invention as embodied in a program product. Persons skilled in the art will recognize immediately that, although most of the exemplary embodiments described in this specification are oriented to software installed and executing on computer hardware, nevertheless, alternative embodiments implemented as firmware or as hardware are well within the scope of the present invention.

Definitions

In this specification, the terms “field,” “data element,” and “attribute,” unless the context indicates otherwise, generally are used as synonyms, referring to individual elements of digital data. Aggregates of data elements are referred to as “records” or “data structures.” Definitions of complex data structures that include member methods, functions, or software routines in addition to data elements are referred to as “classes.” Instances of complex data structures are referred to as “objects” or “class objects.” Aggregates of records are referred to as “tables” or “files.” Aggregates of files are referred to as “databases.”

“Anchor element” refers to a markup language element that identifies and implements a link or web link or hyperlink. Links are the basic hypertext construct, the central function of the web. A common example form of an anchor element is:

<a href=“\\SrvrX\DocY”>Press Here For Document Y </a>

This example includes a start tag <a>, and end tag </a>, an href attribute that identifies the target of the link as a document named ‘DocY’ on a web server named ‘SrvrX,’ and an anchor. The anchor is the text “Press Here For Document Y.” In typical usage, the anchor is displayed in highlighting, underscored, inverse, specially colored, or some other fashion serving to set it apart from other screen text. In addition, the screen display area of the anchor is sensitized to GUI pointer operation such as mouseclicks. In operation, a user points to the anchor, clicks it to invoke the link, and the browser then retrieves and displays Document Y from server SrvrX. The “anchor element” is the entire markup from the start tag to the end tag. The “anchor” is the display text that is set forth between the start tag and the end tag.

“Browser” means a web browser, a software application for locating and displaying web pages. Browsers typically comprise both a markup language interpreter, web page display routines, and an HTTP communications client. Typical browsers today can display text, graphics, audio and video. Browsers are operative in web-enabled devices, including wireless web-enabled devices. Browsers in wireless web-enabled devices often are downsized browsers called “microbrowsers.” Microbrowsers in wireless web-enabled devices often support markup languages other than HTML, including for example, WML and HDML.

“HDML” stands for ‘Handheld Device Markup Language,’ a markup language for web content for Web-enabled mobile phones. HDML is Openwave's (formerly known as phone.com) proprietary language. HDML can only be viewed on mobile phones that use Openwave browsers. HDML was developed and distributed before the WAP initiative was begun. HDML uses Openwave's Handheld Device Transport Protocol (HDTP), instead of WAP. HDML is most popular in North America. In Europe, WML is the emerging standard. Some versions of Openwave browsers do interpret basic WML.

“HTML” stands for ‘HypterText Markup Language,’ a standard markup language for displaying web pages on browsers.

“HTTP” stands for ‘HyperText Transport Protocol,’ the standard data communications protocol of the World Wide Web.

“LAN” means local area network.

“Network” is used in this specification to mean any networked coupling for data communications. Examples of networks useful with the invention include intranets, extranets, internets, local area networks, wide area networks, and other network arrangements as will occur to those of skill in the art.

“Server” in this specification refers to a computer or device comprising automated computing machinery on a network that manages network resources. A “web server” in particular is a server that communicates with browsers by means of HTTP in order to manage and make available to networked computers markup language documents and digital objects.

A “URI” or “Universal Resource Identifier” is an identifier of a named object in any namespace accessible through a network. URI are functional for any access scheme, including for example, the File Transfer Protocol or “FTP,” Gopher, and of course the “web,” the “World Wide Web.”

URLs as used in typical embodiments of the present invention usually includes an internet protocol address, or a domain name that resolves to an internet protocol address, identifying a location where a resource, particularly a web pages, a CGI script, or a servlet, is located on a network, usually the Internet. URLs directed to particular resources, such as particular HTML files, JPEG files, or MPEG files, typically include a path name or file name locating and identifying a particular resource in a file system coupled to a network. To the extent that a particular resource, such as a CGI file or a servlet, is executable, a URL often includes execution parameters.

“URLs” or “Universal Resource Locators” comprise a kind of subset of URIs, wherein each URL resolves to a network address. That is, URIs and URLs are distinguished in that URIs identify named objects in namespaces, where the names may or may not resolve to addresses, while URLs do resolve to addresses. Although all standards today are written on the basis of URIs, it is still common to such see web-related identifiers, of the kind used to associate web data locations with network addresses for data communications, referred to as “URLs.” In this specification, we refer to such identifiers generally as URIs.

“WAP” stands for ‘Wireless Application Protocol,’ a proposed web-related data communications specification, or ‘initiative,’ directed toward wireless web enabled devices such as mobile phones, pagers, two-way radios, smartphones and communicators. WAP supports most wireless networks, including for example, CDPD, CDMA, GSM, PDC, PHS, TDMA, FLEX, ReFLEX, iDEN, TETRA, DECT, DataTAC, and Mobitex. WAP is supported by most operating systems, including those designed specifically engineered for wireless web enabled devices such as PalmOS, EPOC, Windows CE, FLEXOS, OS/9, and JavaOS. WAP implementations that use displays and access the Internet run microbrowsers, browsers with small file sizes that can accommodate low memory constraints of handheld devices and low-bandwidth constraints often associated with wireless networks. Although WAP supports HTML and XML, the WML language (an XML application) is specifically devised for small screens and one-hand navigation without a keyboard.

“Wireless web-enabled device” means any web-enabled device capable of establishing HTTP communications with a web server through WAP or other wireless protocols. Examples of wireless web-enabled devices are personal computers, lap-top computers, internet-enabled special purpose devices, internet-capable personal digital assistants (“PDAs”), mobile phones, pagers, two-way radios, smartphones, communicators, and others devices of the kind as will occur to those of skill in the art. It is common, although not a required element of the present invention, for wireless web-enabled devices to be hand held devices.

“Web-enabled device” means any device capable of establishing HTTP communications with a web server. Examples of web-enabled devices are personal computers, lap-top computers, internet-enabled special purpose devices, internet-capable personal digital assistants (“PDAs”), mobile phones, pagers, two-way radios, smartphones, communicators, and others devices of the kind as will occur to those of skill in the art.

“WML” stands for ‘Wireless Markup Language,’ an XML language used as a markup language for web content intended for wireless web-enabled devices that implement WAP. There is a WAP forum that provides a DTD for WML. A DTD is an XML ‘Document Type Definition.’

“World Wide Web,” or more simply “the web,” refers to a system of internet protocol (“IP”) servers that support specially formatted documents, documents formatted in markup languages such as HTML, XML, WML, or HDML. The term “Web” is used in this specification also to refer to any server or connected group or interconnected groups of servers that implement the HyperText Transport Protocol, “HTTP,” in support of URIs and documents in markup languages, regardless whether such servers or groups of servers are coupled to the World Wide Web as such.

“XML” stands for ‘extensible Markup Language,’ a language that support user-defined markup including user-defined elements, tags, and attributes. XML's extensibility contrasts with most web-related markup languages, such as HTML, which are not extensible, but which instead use a standard defined set of elements, tags, and attributes. XML's extensibility makes it a good foundation for defining other languages. WML, for example, is a markup language based on XML.

“TDMA” stands for Time Division Multiple Access, a technology for delivering digital wireless service using time-division multiplexing. TDMA works by dividing a radio frequency into time slots and then allocating slots to multiple calls. In this way, a single frequency can support multiple, simultaneous data channels. TDMA is used by GSM.

“GSM” stands for Global System for Mobile Communications, a digital cellular standard. GSM at this time is the de facto standard for wireless digital communications in Europe and Asia. GSM supports communications bandwidths of up to about 9.6 Kbps.

“CDPD” stands for Cellular Digital Packet Data, a data transmission technology developed for use on cellular phone frequencies. CDPD uses unused cellular channels to transmit data in packets. CDPD supports data transfer rates of up to 19.2 Kbps.

“GPRS” stands for General Packet Radio Service, a standard for wireless data communications which runs at speeds up to 150 Kbps, compared with current GSM systems which cannot support more than about 9.6 Kbps. GPRS, which supports a wide range of speeds, is an efficient use of limited bandwidth and is particularly suited for sending and receiving small bursts of data, such as e-mail and Web browsing, as well as large volumes of data.

“EDGE” stands for Enhanced Data Rates for GSM Evolution, a standard for wireless data communications supporting data transfer rates of more than 300 Kbps. GPRS and EDGE are considered interim steps on the road to UMTS.

“UMTS” stands for Universal Mobile Telecommunication System, a standard for wireless data communications supporting data transfer rates of up to 2 Mpbs. UMTS is also referred to W-CDMA for Wideband Code Division Multiple Access.

### DETAILED DESCRIPTION

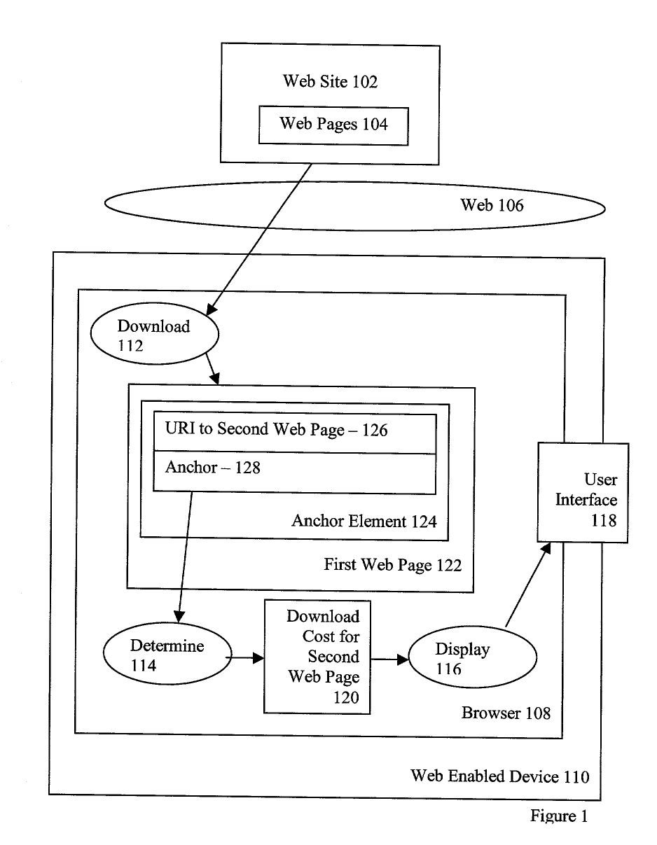

As shown in FIG. 1, exemplary embodiments of the invention typically include methods for calculating and displaying the cost of downloading web content. Typical embodiments include downloading (112), from a web site (102) into a browser (108) on a web-enabled device (110), a first web page (122). In typical embodiments, the first web page includes at least one hyperlink anchor element (124). The hyperlink anchor element (124) typically includes a URI (126) identifying a second web page. The hyperlink anchor element (124) typically includes text comprising a hyperlink anchor (128), and the web-enabled device (110) includes a user interface (118). Exemplary embodiments typically include determining (114) a download cost (120) for the second web page and displaying (116), through the user interface (118), the download cost (120) for the second web page.

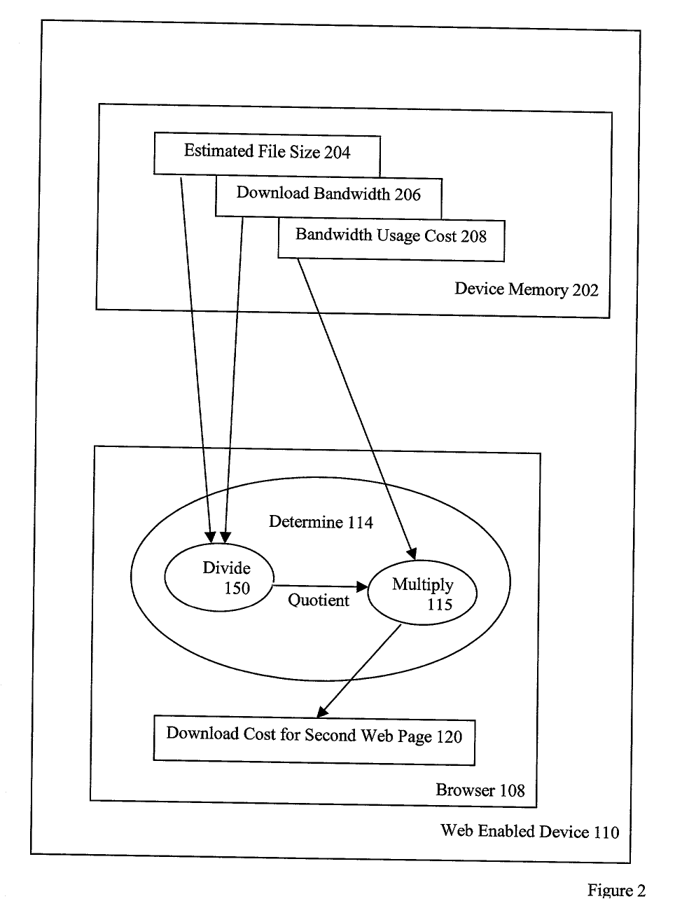

Turning now to FIG. 2, a further example embodiment of the invention is illustrated in which determining (114) a download cost for the second web page includes dividing (150) an estimated file size for the second web page (204) by a download bandwidth (206) for the web-enabled device (110), yielding a quotient, and multiplying (115) the quotient by a bandwidth usage cost (208) for the web-enabled device. If, for example, the estimated file size for downloads is 1.0 KB, the download bandwidth is 19.2 KB/second (as in a CDPD network), and the bandwidth usage cost is $0.10/second, then the estimate time for a download of a second web page is

1.0 KB/19.2 KB/second=0.052 seconds (the ‘quotient’),

and the download cost for a second web page then is

0.052 seconds×$0.10/second=$0.0052.

In embodiments of the kind illustrated in FIG. 2, the browser often is extended to support a data entry screen through which a user can enter directly into the browser's configuration parameters the estimated file size (204) for downloads, as well as a download bandwidth (206) and a bandwidth usage cost (208). Such data entry is typically a part of an initial setup operation for the web-enabled device, and the data entry for the estimated file size (204) for downloads, download bandwidth (206) and bandwidth usage cost (208) is editable at user discretion at any time. It is typical for the download bandwidth, particularly in the case of downloads to browsers in wireless web-enabled devices, to be a particular bandwidth associated with a particular communications network type, such as, for example, GSM, CDPD, or GPRS, and it is typical for a bandwidth usage cost to be a cost associated with the network type. Because bandwidth costs are often determined by network type or network bandwidth, it is often the case that bandwidth usage costs are established and charged by ISPs or telecomm providers, wired or wireless. This kind of embodiment, the kind shown in FIG. 2, is useful for estimating download costs, particularly for applications in which the download file size does not vary widely and the bandwidth usage cost does not change very often.

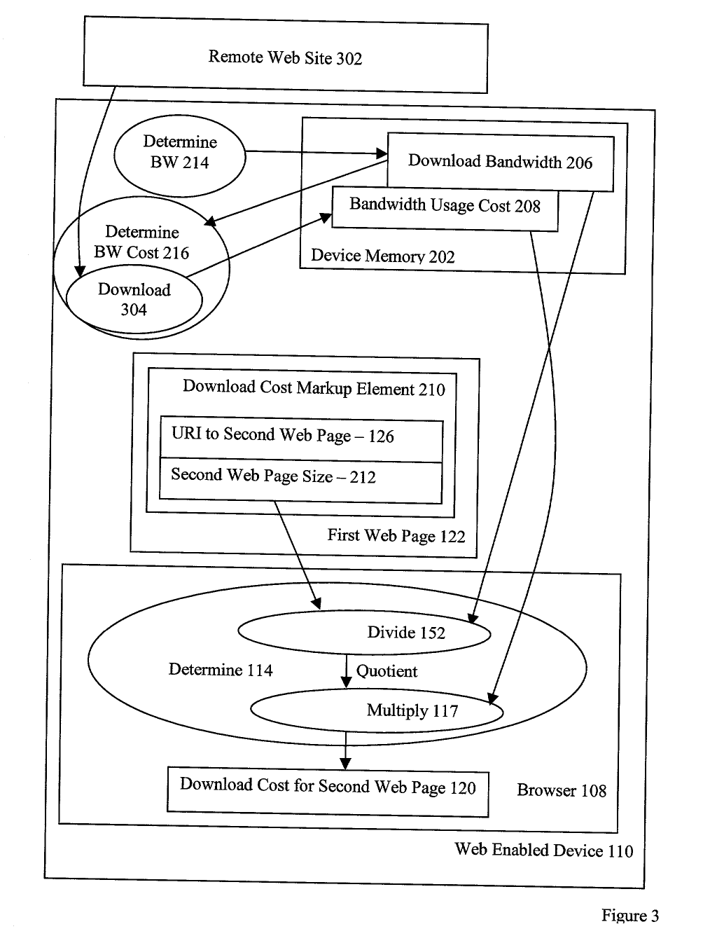

In exemplary embodiments of the kind illustrated in FIG. 3, the first web page (122) typically includes a download cost markup element (210) for the second web page. In typical embodiments, the download cost markup element includes the URI identifying the second web page (126) as well as the size of the second web page (212). An example of download cost markup element of a kind useful in various embodiments of the present invention is:

\\SomeServerName\CGI\CostScript-01.cgi

?SecondPageURI=“\\SomeServer\MyPages\PageNo2”

?Size=“2.0 KB”

In such embodiments determining a download cost for the second web page (114) typically includes determining a download bandwidth for use by the web-enabled device (214), determining a bandwidth cost (216) in dependence upon the download bandwidth, dividing (152) the second web page size (212) by the download bandwidth (206), thereby yielding a quotient; and multiplying (117) the quotient by the bandwidth usage cost (208).

This functionality, as well as most of the functionality typical of various embodiments of the invention is implemented in a browser plug-in or in expanded programming of a browser at the source code level. The core functionality needed to implement embodiments of the present invention typically is embedded in a browser's processing sequence before the browser's usual markup interpreter and display routines, so that whatever calculations or modifications need to be done to implement an embodiment of the present invention typically occurs transparently to normal browser operations.

In particular, determining a download bandwidth typically includes user data entry of a download bandwidth into browser parameter memory through a data entry screen or dialogue box provided for that purpose. In a wireless example, if a user's wireless digital network is GPRS, then the maximum bandwidth supported is 150 Kbps. Particular providers, wired or wireless, may make lesser bandwidths available at reduced cost, and users may choose smaller bandwidths when, for example, a user intends to download several small documents and is therefore less concerned with speed. Larger documents may require higher download bandwidths for which the user is willing to pay more in order to reduce download time. In many embodiments, therefore, both the maximum bandwidth for the network type and lesser bandwidths are made available for user selection through the usual GUI objects such as pull down menus, radio buttons, and dialogue boxes.

Embodiments of the kind illustrated in FIG. 3 typically include determining a bandwidth cost (216) in dependence upon the download bandwidth (206). More particularly, in such embodiments, it is typical for the browser to be programmed to query and download (304) from a remote web site (302) the bandwidth usage cost (208). In such embodiments, the remote web site manages cost tables that include bandwidth usage costs sorted or indexed according to download bandwidth. As mentioned earlier, it is often the case that the download bandwidth is a bandwidth associated with a communications network type, such as, for example, GSM, CDPD, or GPRS, and it is therefore common for a bandwidth usage cost to be a cost associated with a network type.

Because bandwidth costs are often determined by network type, it is common for bandwidth usage costs to be established and charged by ISPs or telecomm providers. It is often the case, therefore, that the remote web site queried for bandwidth usage costs, in various embodiments of the present invention, is a web site of an ISP or telecomm provider. In embodiments of the kind shown in FIG. 3, when the user chooses a download bandwidth, the browser then queries the remote web site for a bandwidth usage cost based upon the selected download bandwidth, downloads (304) the bandwidth usage cost (208), and stores it in device memory (202).

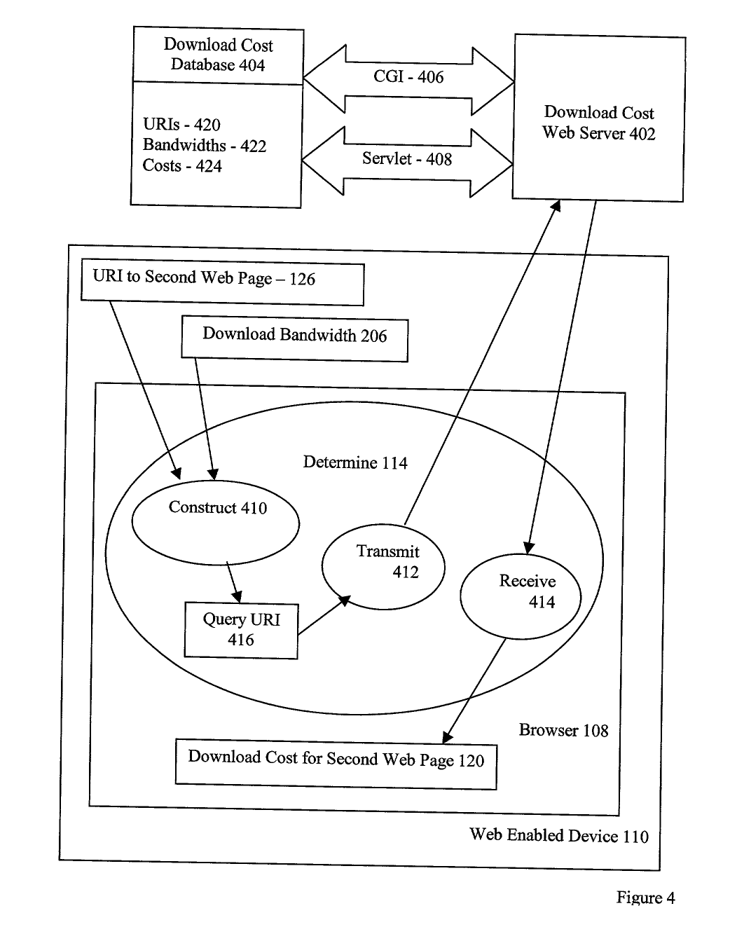

Turning now to FIG. 4, a further embodiment of the invention is shown in which determining a download cost for the second web page (114) includes constructing (410), in the browser (108), a query URI (416) representing a query of a download cost database (404) through a download cost web server (402) for the download cost for the second web page. In such embodiments, for example, a query URI (416) id typically includes the URI identifying the second web page (126) and a download bandwidth (206) for the web-enabled device. Here is an example that illustrates a form of query URI useful in various embodiments:

\\SomeServerName\Servlet\CostServlet#007

?SecondPageURI=“\\SomeServer\MyPages\PageNo2”

?DownloadBandwidth=“19.2 Kbps”

This example URI targets a Java servlet for its database query, whereas our earlier example URI set forth above targeted a CGI script. Any method of database query is well within the scope of the present invention. This form of query URI too is only exemplary. Persons of skill in the art will derive many forms of query URI, all of which are well within the scope of the present invention.

In typical embodiments of the kind illustrated in FIG. 4, a download cost database (404) includes data fields for URIs identifying web pages (420), download bandwidths (422), and download costs (424). Such databases support queries for download costs on the basis of the search parameters: a URI identifying a web page (in our examples, the ‘second’ web page) and a download bandwidth. Such embodiments typically transmit (412) the query URI (416) to the download cost web server (402) in an HTTP ‘get’ message and receive (414), as a query result from the download cost web server, the download cost for the second web page (120).

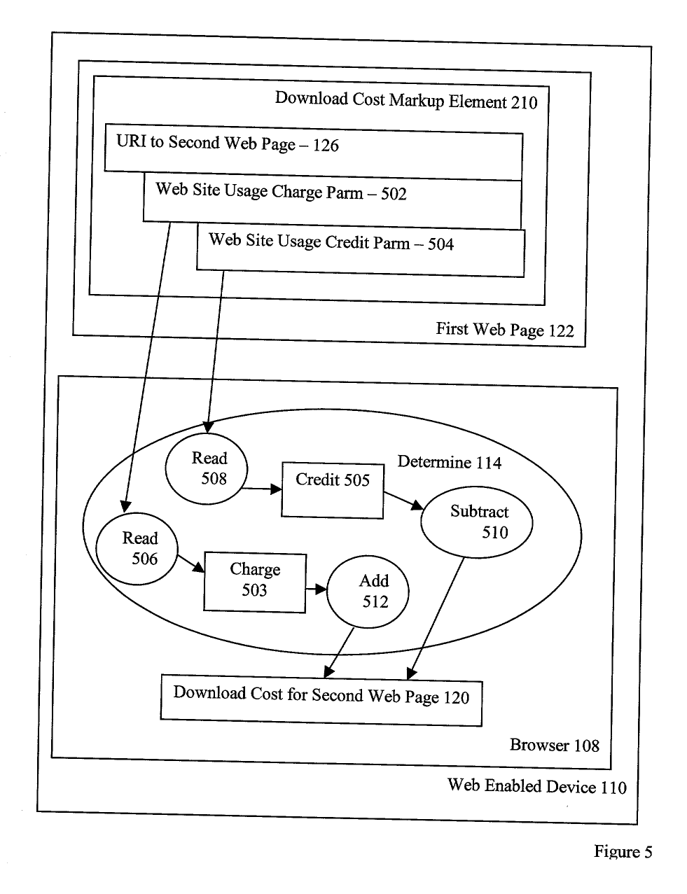

Turning now to FIG. 5, a further exemplary embodiment is shown in which the first web page (122) includes a download cost markup element (210) for the second web page. In embodiments of the kind illustrated in FIG. 5, the download cost markup element typically includes the URI identifying the second web page (126), and a web site usage charge parameter (502) identifying a web site usage charge for downloading the second web page. Such download cost markup elements are defined, for example, by software developers in extensible markup languages such as XML and have, for example, a form similar to the following:

<DownloadCost SecondPageURI=“\\SomeServer\MyPages\PageNo2” SiteUseChg=“$0.02”> </DownloadCost>

This example illustrates a download cost markup element, in XML format, having a start tag of <DownloadCost>, and end tag of </DownloadCost>, and attributes of ‘SecondPageURI’ and ‘SiteUseChg.’ In this example, the attribute SecondPageURI identifies the URI identifying the second web page (126), and the attribute SiteUseChg implements the web site usage charge parameter (502). As persons of skill in the art will realize, such a markup element is created by registering it in an XML name space and describing its characteristics in a ‘DTD’ or ‘Document Type Definition.’ This example of a download cost markup element is oriented to XML for purposes of illustration. Persons of skill in the art will realize that download cost markup elements also will be implemented as <meta> tags in HTML-oriented embodiments. In embodiments direct toward Microsoft's Internet Explorer™ browser in particular, the dynamic list tag often is created by use of DHTML scriptlets or by use of custom ‘behaviors.’ For more details regarding scriptlets and behaviors, readers are directed to the Microsoft Developer Network article entitle “Understanding Scriptlets and Behaviors” at http://msdn.microsoft.com/library/default.asp?url=/library/en-us/modcore/html/deovrUnderstandingScriptletsBehaviors.asp. In fact, persons of skill in the art will determine many ways of establishing useful download cost markup elements and all such ways are well within the scope of the present invention.

In embodiments of the kind illustrated in FIG. 5, determining (114) a download cost for the second web page typically includes reading (506), from the web site usage charge parameter (502) in the first web page, a web site usage charge (503) for downloading the second web page, and adding (512) the web site usage charge (503) to the download cost (120) for the second web page. For various business reasons, such as promotions, advertising, business development, usage incentives, or to defray usage charges for users of web-enabled devices, for example, web sites, web site owners, or content providers make available from time to time financial credits for use of a web site. In embodiments of the kind illustrated in FIG. 5, therefore, determining (114) a download cost for the second web page typically includes reading (508), from the web site credit parameter (504) for the first web page, a web site usage credit (505) for downloading the second web page, and subtracting (510) the web site usage credit (505) from the download cost (120) for the second web page. A download cost markup element providing for web site usage credits is defined, for example, in a form illustrated by the following:

<DownloadCost SecondPageURI=“\\SomeServer\MyPages\PageNo2” SiteUseChg=“$0.02” SiteUseCred=“$0.01”> </DownloadCost>

This example is similar to the one set forth earlier except that it now includes an additional attribute ‘SiteUseCred’ that implements a web site credit parameter (504). Again, this form of download cost markup element is exemplary. Persons of skill will define many forms of download cost markup element and they are all well within the scope of the present invention.

A download cost markup element providing for PDA page charges in addition to site usage charges and credits also can be defined, for example, in a form illustrated by the following:

<DownloadCost SecondPageURI=“\\SomeServer\MyPages\PageNo2” SiteUseChg=“$0.02” SiteUseCred=“$0.01” PDAPages=“6” PDAPerPageChg=“$0.03”> </DownloadCost>

In embodiments that utilize PDA page charges, determining (114) a download cost for a second web page typically includes reading the number of PDA pages and the per page charge from the download cost markup element, multiplying them, and adding the result to the download cost for the second page. This latter example regarding PDA pages illustrates that any download-related cost or credit can be easily incorporated into embodiments of the present invention, and such incorporation of any conceivable download-related cost or credit is well within the scope of the present invention.

Once again, more over, we have discussed the PDA example download cost markup elements in terms of user-defined XML elements. Persons of skill in the art will realize that download cost markup elements also will be implemented as <meta> tags in HTML-oriented embodiments. Even the ‘microbrowsers’ common in PDAs may support DHTML scriptlets and behaviors. In fact, as mentioned earlier, persons of skill in the art will determine many ways of establishing useful download cost markup elements and all such ways are well within the scope of the present invention.

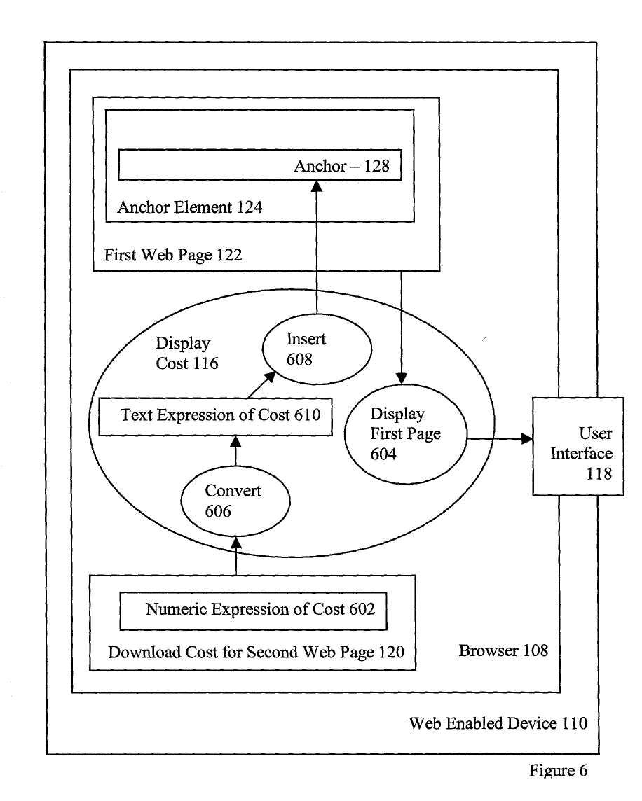

Turning now to FIG. 6, a further exemplary embodiment of the invention is illustrated in which the download cost for the second web page (120) comprises a numeric download cost (602). In typical embodiments of the kind shown in FIG. 6, a hyperlink anchor element (124) includes text comprising a hyperlink anchor (128). In such embodiments displaying (116) the download cost for the second web page includes converting (606) the numeric download cost (602) for the second web page to a text download cost (610) for the second web page, inserting (608) the text download cost (610) into the hyperlink anchor (128), and displaying (604) the first web page. This processing of the expression of the download cost illustrates that the processing of the present invention, in typical embodiments, occurs before the normal browser functions of markup interpretation and display of a web page. By the time the browser's normal interpreter receives the first web page for processing, the method of the present invention, in typical embodiments, for example, has inserted a text expressions of download cost into the pertinent text anchors so that display of the anchors occurs normally in the browser without the browser's interpreter or display routines ever knowing that anything has been changed.

It will be understood from the foregoing description that various modifications and changes may be made, and naturally will be made, in the exemplary embodiments of the present invention without departing from its true spirit. The descriptions in this specification are for purposes of illustration only and are not be construed in a limiting sense. The scope of the present invention is limited only by the language of the following claims.

What is claimed is:

1. A method for calculating and displaying the cost of downloading web content, the method comprising:
downloading to a browser, a first web page, the first web page comprising at least one hyperlink anchor element, the hyperlink anchor element comprising a URI identifying a second web page and text comprising a hyperlink anchor,
determining a download cost for the second web page;
displaying the download cost for the second web page.

2. The method of claim 1 wherein determining a download cost for the second web page further comprises:
dividing an estimated file size for the second web page by a download bandwidth, thereby yielding a quotient; and
multiplying the quotient by a bandwidth usage cost.

3. The method of claim 1 wherein the first web page comprises a download cost markup element for the second web page, the download cost markup element comprises the URI identifying the second web page and a second web page size, and determining a download cost for the second web page further comprises:
determining a download bandwidth;
determining a bandwidth cost in dependence upon the download bandwidth;
dividing the second web page size by the download bandwidth, thereby yielding a quotient; and
multiplying the quotient by the bandwidth usage cost.

4. The method of claim 3 wherein determining a bandwidth cost in dependence upon the download bandwidth further comprises downloading from a remote web site the bandwidth usage cost.

5. The method of claim 1 wherein determining a download cost for the second web page further comprises:
constructing, in the browser, a query URI representing a query of a download cost database through a download cost web server for the download cost for the second web page, wherein
the query URI comprises the URI identifying the second web page and a download bandwidth, and
the download cost database comprises data fields for URIs identifying web pages, download bandwidths, and download costs; and
transmitting the query URI to the download cost web server in an HTTP ‘get’ message; and
receiving, as a query result from the download cost web server, the download cost for the second web page.

6. The method of claim 1 wherein the first web page comprises a download cost markup element for the second web page, the download cost markup element comprises the URI identifying the second web page and a web site usage charge parameter identifying a web site usage charge for downloading the second web page, and determining a download cost for the second web page further comprises:
reading, from the web site usage charge parameter, a web site usage charge for downloading the second web page; and
adding the web site usage charge to the download cost for the second web page.

7. The method of claim 6 wherein the first web page comprises an HTML document, the HTML document comprises a header, and the download cost markup element comprises a <meta> tag in the header of the HTML document.

8. The method of claim 1 wherein the first web page comprises a download cost markup element for the second web page, the download cost markup element comprises the URI identifying the second web page and a web site usage credit parameter identifying a web site usage charge for downloading the second web page, and determining a download cost for the second web page further comprises:
reading, from the web site credit parameter, a web site usage credit for downloading the second web page; and
subtracting the web site usage credit from the download cost for the second web page.

9. The method of claim 8 wherein the first web page comprises an HTML document, the HTML document comprises a header, and the download cost markup element comprises a <meta> tag in the header of the HTML document.

10. The method of claim 1 wherein the download cost for the second web page comprises a numeric download cost, the hyperlink anchor element comprises text comprising a hyperlink anchor, and displaying the download cost for the second web page further comprises:
converting the numeric download cost for the second web page to a text download cost for the second web page;
inserting the text download cost into the hyperlink anchor; and
displaying the first web page.

11. A system for calculating and displaying the cost of downloading web content, the system comprising:
means for downloading to a browser, a first web page, the first web page comprising at least one hyperlink anchor element, the hyperlink anchor element comprising a URI identifying a second web page and text comprising a hyperlink anchor,
means for determining a download cost for the second web page;
means for displaying the download cost for the second web page.

12. The system of claim 11 wherein means for determining a download cost for the second web page further comprises:
means for dividing an estimated file size for the second web page by a download bandwidth, thereby yielding a quotient; and
means for multiplying the quotient by a bandwidth usage cost.

13. The system of claim 11 wherein the first web page comprises a download cost markup element for the second web page, the download cost markup element comprises the URI identifying the second web page and a second web page size, and means for determining a download cost for the second web page further comprises:
means for determining a download bandwidth;
means for determining a bandwidth cost in dependence upon the download bandwidth;
means for dividing the second web page size by the download bandwidth, thereby yielding a quotient; and
means for multiplying the quotient by the bandwidth usage cost.

14. The system of claim 13 wherein means for determining a bandwidth cost in dependence upon the download bandwidth further comprises means for downloading from a remote web site the bandwidth usage cost.

15. The system of claim 11 wherein means for determining a download cost for the second web page further comprises:
means for constructing, in the browser, a query URI representing a query of a download cost database through a download cost web server for the download cost for the second web page, wherein
the query URI comprises the URI identifying the second web page and a download bandwidth, and
the download cost database comprises data fields for URIs identifying web pages, download bandwidths, and download costs; and
means for transmitting the query URI to the download cost web server in an HTTP ‘get’ message; and
means for receiving, as a query result from the download cost web server, the download cost for the second web page.

16. The system of claim 11 wherein the first web page comprises a download cost markup element for the second web page, the download cost markup element comprises the URI identifying the second web page and a web site usage charge parameter identifying a web site usage charge for downloading the second web page, and determining a download cost for the second web page further comprises:
means for reading, from the web site usage charge parameter, a web site usage charge for downloading the second web page; and
means for adding the web site usage charge to the download cost for the second web page.

17. The system of claim 16 wherein the first web page comprises an HTML document, the HTML document comprises a header, and the download cost markup element comprises a <meta> tag in the header of the HTML document.

18. The system of claim 11 wherein the first web page comprises a download cost markup element for the second web page, the download cost markup element comprises the URI identifying the second web page and a web site usage credit parameter identifying a web site usage charge for downloading the second web page, and means for determining a download cost for the second web page further comprises:
means for reading, from the web site credit parameter, a web site usage credit for downloading the second web page; and
means for subtracting the web site usage credit from the download cost for the second web page.

19. The system of claim 18 wherein the first web page comprises an HTML document, the HTML document comprises a header, and the download cost markup element comprises a <meta> tag in the header of the HTML document.

20. The system of claim 11 wherein the download cost for the second web page comprises a numeric download cost, the hyperlink anchor element comprises text comprising a hyperlink anchor, and means for displaying the download cost for the second web page further comprises:
means for converting the numeric download cost for the second web page to a text download cost for the second web page;
means for inserting the text download cost into the hyperlink anchor; and
means for displaying the first web page.

21. A computer program product for calculating and displaying the cost of downloading web content, the computer program product comprising:
a recording medium;
means, recorded on the recording medium, for downloading to a browser, a first web page, the first web page comprising at least one hyperlink anchor element, the hyperlink anchor element comprising a URI identifying a second web page and text comprising a hyperlink anchor,
means, recorded on the recording medium, for determining a download cost for the second web page;
means, recorded on the recording medium, for displaying the download cost for the second web page.

22. The computer program product of claim 21 wherein means, recorded on the recording medium, for determining a download cost for the second web page further comprises:
means, recorded on the recording medium, for dividing an estimated file size for the second web page by a download bandwidth, thereby yielding a quotient; and
means, recorded on the recording medium, for multiplying the quotient by a bandwidth usage cost.

23. The computer program product of claim 21 wherein the first web page comprises a download cost markup element for the second web page, the download cost markup element comprises the URI identifying the second web page and a second web page size, and means, recorded on the recording medium, for determining a download cost for the second web page further comprises:
means, recorded on the recording medium, for determining a download bandwidth;
means, recorded on the recording medium, for determining a bandwidth cost in dependence upon the download bandwidth;
means, recorded on the recording medium, for dividing the second web page size by the download bandwidth, thereby yielding a quotient; and
means, recorded on the recording medium, for multiplying the quotient by the bandwidth usage cost.

24. The computer program product of claim 23 wherein means, recorded on the recording medium, for determining a bandwidth cost in dependence upon the download bandwidth further comprises means, recorded on the recording medium, for downloading from a remote web site the bandwidth usage cost.

25. The computer program product of claim 21 wherein means, recorded on the recording medium, for determining a download cost for the second web page further comprises: means, recorded on the recording medium, for constructing, in the browser, a query URI representing a query of a download cost database through a download cost web server for the download cost for the second web page, wherein
the query URI comprises the URI identifying the second web page and a download bandwidth, and
the download cost database comprises data fields for URIs identifying web pages, download bandwidths, and download costs; and
means, recorded on the recording medium, for transmitting the query URI to the download cost web server in an HTTP ‘get’ message; and
means, recorded on the recording medium, for receiving, as a query result from the download cost web server, the download cost for the second web page.

26. The computer program product of claim 21 wherein the first web page comprises a download cost markup element for the second web page, the download cost markup element comprises the URI identifying the second web page and a web site usage charge parameter identifying a web site usage charge for downloading the second web page, and determining a download cost for the second web page further comprises:
means, recorded on the recording medium, for reading, from the web site usage charge parameter, a web site usage charge for downloading the second web page; and
means, recorded on the recording medium, for adding the web site usage charge to the download cost for the second web page.

27. The computer program product of claim 26 wherein the first web page comprises an HTML document, the HTML document comprises a header, and the download cost markup element comprises a <meta> tag in the header of the HTML document.

28. The computer program product of claim 21 wherein the first web page comprises a download cost markup element for the second web page, the download cost markup element comprises the URI identifying the second web page and a web site usage credit parameter identifying a web site usage charge for downloading the second web page, and means, recorded on the recording medium, for determining a download cost for the second web page further comprises:
means, recorded on the recording medium, for reading, from the web site credit parameter, a web site usage credit for downloading the second web page; and
means, recorded on the recording medium, for subtracting the web site usage credit from the download cost for the second web page.

29. The computer program product of claim 28 wherein the first web page comprises an HTML document, the HTML document comprises a header, and the download cost markup element comprises a <meta> tag in the header of the HTML document.

30. The computer program product of claim 21 wherein the download cost for the second web page comprises a numeric download cost, the hyperlink anchor element comprises text comprising a hyperlink anchor, and means, recorded on the recording medium, for displaying the download cost for the second web page further comprises:
means, recorded on the recording medium, for converting the numeric download cost for the second web page to a text download cost for the second web page;
means, recorded on the recording medium, for inserting the text download cost into the hyperlink anchor; and
means, recorded on the recording medium, for displaying the first web page.
